(19) United States
(12) Patent Application Publication
(10) Pub. No.: US 2007/0055710 A1
(43) Pub. Date: Mar. 8, 2007

(54) BLOCK SNAPSHOTS OVER iSCSI

(75) Inventor: Kirill Malkin, Morris Plains, NJ (US)

Correspondence Address: HESLIN ROTHENBERG FARLEY & MESITI PC, 5 COLUMBIA CIRCLE, ALBANY, NY, 12203, US

(73) Assignee: RELDATA, INC., Parsippany, NJ (US)

(21) Appl. No.: 11/470,545

(22) Filed: Sep. 6, 2006

Related U.S. Application Data
(60) Provisional application No. 60/714,427, filed on Sep. 6, 2005.

(51) Int. Cl. G06F 17/30

(52) U.S. Cl. 707/202

(57) ABSTRACT

A snapshot of the data of a block storage resource is taken and made available over a network via iSCSI. The snapshot can be either read-only or read-write.

### CROSS-REFERENCE TO RELATED APPLICATIONS

This application claims priority under 35 U.S.C. §119 to U.S. Provisional Application No. 60/714,427, filed Sep. 6, 2005, which is herein incorporated by reference in its entirety.

This application contains subject matter which is related to the subject matter of the following applications, each of which is assigned to the same assignee as this application and filed on the same day as this application. Each of the below listed applications is hereby incorporated herein by reference in its entirety:

U.S. patent application Ser. No. ______, by Kirill Malkin, entitled “STORAGE RESOURCE SCAN” (Attorney Docket No. 2660.001A)

U.S. patent application Ser. No. ______, by Malkin et al., entitled “REDUNDANT APPLIANCE CONFIGURATION REPOSITORY IN STANDARD HIERARCHICAL FORMAT” (Attorney Docket No. 2660.002A)

U.S. patent application Ser. No. ______, by Malkin et al., entitled “LIGHTWEIGHT MANAGEMENT AND HIGH AVAILABILITY CONTROLLER” (Attorney Docket No. 2660.003A)

U.S. patent application Ser. No. ______, by Kirill Malkin, entitled “GENERATING DIGEST FOR BLOCK RANGE VIA iSCSI” (Attorney Docket No. 2660.005A)

U.S. patent application Ser. No. ______, by Kirill Malkin, entitled “INCREMENTAL REPLICATION USING SNAPSHOTS” (Attorney Docket No. 2660.006A)

U.S. patent application Ser. No. ______, by Kirill Malkin, entitled “PERFORMANCE IMPROVEMENT FOR BLOCK SPAN REPLICATION” (Attorney Docket No. 2660.007A)

U.S. patent application Ser. No. ______, by Dmitry Fomichev, entitled “REUSING TASK OBJECT AND RESOURCES” (Attorney Docket No. 2660.008A)

### BACKGROUND OF THE INVENTION

1. Technical Field

The present invention generally relates to taking snapshots of data. More particularly, the present invention relates to providing data snapshots over iSCSI.

2. Background Information

It is often useful to be able to freeze the state of data stored on a block storage device for various purposes, for example, backup, data recovery, comparison, experimentation, testing, replication, etc. At the same time, however, the data needs to be available for normal operations. Depending on the amount of data involved, which can be quite large, making an actual copy of the data is often impractical, for performance, space and bandwidth reasons, especially if the data needs to be used at a remote location.

Snapshots provide the necessary freezing of the data while also providing continued access to the data for normal processing, and without affecting performance. Utilization of snapshots other than locally heretofore has been accomplished by, for example, presenting the snapshot data as part of the file system residing on a block storage device. However, such methods do not provide the independence and flexibility desired or required. Moreover, certain uses for the snapshots may require immutable (read-only) snapshots, while access to the data on the block storage volume is almost always read-write.

Thus, a need exists for a way to provide simple, independent and flexible access to different types of snapshots coherent with the use of the snapshot.

### SUMMARY OF THE INVENTION

Briefly, the present invention satisfies the need for simple access to different types of snapshots depending on use, by providing access to read-only and read-write snapshots via iSCSI.

In accordance with the above, it is an object of the present invention to provide simple, flexible and independent access to data snapshots.

It is another object of the present invention to provide different types of snapshots depending on the intended use.

The present invention provides, in a first aspect, a method of providing a snapshot of data on a network. The method comprises taking a snapshot of a block storage resource on the network, and exporting the snapshot over the network as an iSCSI target.

The present invention provides, in a second aspect, a system for providing a snapshot of data on a network. The system comprises a block storage resource coupled to a network, means for taking a snapshot of the block storage resource, and means for exporting the snapshot over the network as an iSCSI target.

The present invention provides, in a third aspect, at least one program storage device readable by a machine tangibly embodying at least one program of instructions executable by the machine to perform a method of providing a snapshot of data on a network. The method comprises taking a snapshot of a block storage resource on the network, and exporting the snapshot over the network as an iSCSI target.

Either type of snapshot, read-only or read-write, is accessed on the network in the same fashion as the block storage resource from which the snapshot is taken. In other words, the block storage resource facilitated by the snapshot looks and feels like any other instance or copy of the block storage resource from which the snapshot is made. As a consequence, the snapshot can be used as a different instance of the origin, whether the origin be a database, file system or serves some other purpose. Read-write snapshots give the additional flexibility of modifying the data from the origin storage resource without affecting the origin.

Either type of snapshot, read-only or read-write, is accessed on the network in the same fashion as the block storage resource of which the snapshot is taken. In other words, the block storage resource facilitated by the snapshot looks and feels like any other instance or copy of the origin block storage resource from which the snapshot is taken. As a consequence, the snapshot can be used as a different instance of the origin, whether the origin is a database, file system or serves some other purpose. Read-write snapshots give the additional flexibility of modifying the data from the origin storage resource without affecting the origin.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 is a block diagram of one example of a simple block storage resource showing the effects of a read-only snapshot of the block resource over time.

FIG. 2 is a block diagram of one example of a simple block storage resource showing the effects of a read-write snapshot of the block resource over time.

### DETAILED DESCRIPTION OF THE INVENTION

The present invention exports a snapshot of data as an iSCSI target as if it were a regular volume, in read-only or read-write form. A read-only snapshot refers to a snapshot of a block storage resource that presents an exact copy of data of the block storage resource at the time of the snapshot request, and that can no longer be modified (written to). A read-write snapshot refers to a snapshot of a block storage resource that presents an exact copy of data of the block storage resource at the time of the snapshot request, but can be further modified (written to) as if it were a regular read-write block storage resource, except that any changes made do no affect the origin block storage resource. As noted above, either type of snapshot, read-only or read-write, is accessed on the network in the same fashion as the block storage resource of which the snapshot is taken. Read-only snapshots can be used for such purposes as backup, data recovery and comparison. Read-write snapshots can be used for even more varied purposes, such as, for example, booting servers, running databases, testing modifications, and development. For purposes of the present invention, the actual procedure used to create a snapshot is not relevant; conventional methods can be used.

As one skilled in the art will know, a block storage resource is a random-access storage resource that has data organized in equal-sized blocks, typically 512 bytes each. Each block can be written or read in its entirety, but one can't read or update less than the entire block. The blocks are numbered from 0 to the maximum number of blocks of the resource. Blocks are referenced by their numbers, and the access time for any block number is fairly similar across the entire resource. Blocks can also be grouped into equal size “chunks” of blocks. Hard disks, as well as compact flash and USB sticks, are examples of block storage resources.

Block storage resources can be physical or virtual. A physical storage resource is a physical device, such as a hard disk or a flash card, that has a fixed number of blocks that is defined during manufacturing or low-level formatting process, usually at the factory. A virtual block storage resource is a simulated device that re-maps its block numbers into the block numbers of a portion of one or more physical block storage resources. As just two examples, a virtual block storage resource with 2,000 blocks can be mapped to: (1) a single physical block storage resource with 10,000 blocks, starting at block 1,000 and ending at block 2,999; or (2) two physical block storage resources, one with 1,000 blocks and another with 5,000 blocks, starting at block 0 and ending at block 999 of the first resource, then starting at block 3,000 and ending at block 3,999 of the second resource. The examples herein assume the use of virtual block storage resources. However, it will be understood that physical block storage resources could instead be used.

As one skilled in the art will know, snapshots are facilitated by so-called Copy-On-Write (COW) technology, explained more fully below. In addition, a snapshot does not actually make a copy of the data. Rather, as noted above, pointers (i.e., entries in exception tables) are used in conjunction with copies of blocks that are modified, in order to keep a record of the state of the data at the time of the snapshot. Each exception table entry is essentially a pointer with at least the block or chunk number in origin block storage resource that has been overwritten, and an address for the area of the COW that contains the origin data prior to being overwritten. There could also be additional information in an exception table entry, such as, for example, a timestamp of the creation of the entry. In this way, data can be frozen for various uses without actually affecting the data and without, for example, making an actual copy and sending a large amount of data, saving time and bandwidth. Exception tables actually exist both in memory for consulting, and as part of a COW for persistency, so that a table could be restored after a restart.

For purposes of snapshots, COW occurs when a write operation for a block is directed towards the origin resource that has one or more snapshots. In the present example, a single COW per volume is assumed, which is shared by snapshots of the same volume. However, it will be understood that a separate COW could be created for each snapshot, rather than using different areas of the same COW. If the block has not been written since the last snapshot, then before the write operation occurs, the content of the block is read and written out to a specially allocated storage area called “COW device.” Simultaneously, a corresponding exception table entry is created. Then the origin resource block is written with a new data. Subsequently, if the origin resource is read, then it would return the data from the block that was just written out; if the snapshot is read, then the exception table is consulted first, and since there is an entry for this block, the content is returned from the COW device. Note that an exception table is created for each snapshot.

SCSI (Small Computer System Interface) is a set of standards to provide interoperability between conforming systems, primarily between storage devices and client hosts. Compliant client hosts are called SCSI initiators and compliant storage servers are called SCSI targets. SCSI devices may communicate with each other using various physical links (aka transport protocols)—parallel and serial interfaces, fiber channel links, TCP/IP, etc.

The main path of SCSI operation is performed as follows. A SCSI initiator sends commands (requests) to a SCSI target for execution and once the request is completed, the target returns an appropriate response to the client initiator. SCSI commands and responses may be accompanied with significant amount of data, which, in turn, requires initiators and targets to maintain some memory buffer space to hold this data during processing. Normally, this memory is not contiguous, but organized as a list of memory buffers, called scatter-gather list.

iSCSI is a standard protocol to facilitate SCSI functionality when operating over TCP/IP transport. iSCSI devices, when communicating with each other, create an initiator-target nexus in the form of iSCSI session. One of the most important implementation goals for iSCSI devices is to achieve adequate or better performance comparing to other available SCSI transport protocols.

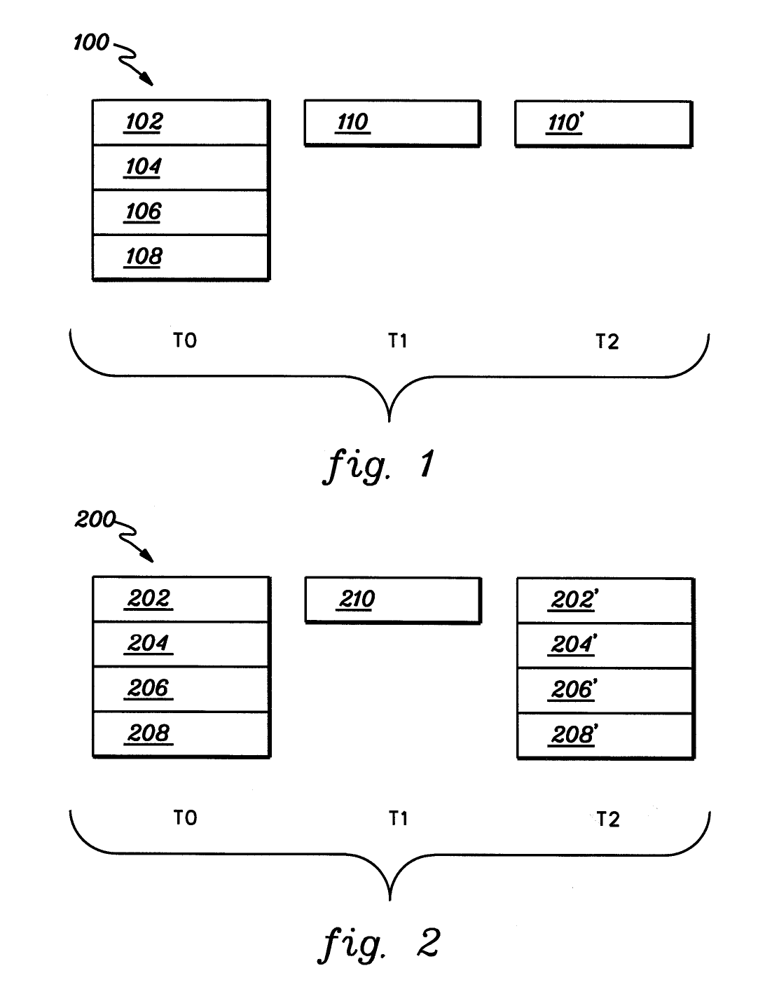

The effects over time of a read-only snapshot will now be described with reference to FIG. 1. Depicted in FIG. 1 is a block storage resource 100 at time T0. Assume that block storage resource 100 is part of an otherwise conventional computing network (e.g., LAN or WAN) in which iSCSI is used as a data transport protocol. The storage resource comprises four data storage blocks, 102, 104, 106 and 108. Assume that a request for a read-only snapshot of the storage resource has been made and the snapshot created and exported as an iSCSI target in the same manner as any iSCSI target. The request is typically received by the operating system and forwarded to a controller for the block storage resource. At time T1, a request to modify the contents of block 102 is received. In order to preserve the data in block 102, and, hence, preserve the snapshot as read-only, a copy of block 102 is made in a spare block 110. Then, at time T2, the modification to the data from block 102 can be made, shown by reference 110′. More technically, in order that the system treats the snapshot as a separate entity, a pointer is used to point to block 110, rather than 102. In this manner, if the requestor wanted to modify block 102, for example, the requestor would “think” it is modifying block 102, when it would actually be modifying a copy of block 102. From this point forward, until the snapshot is deleted, the contents of block 110 will be treated as though it were the data in block 102.

As one skilled in the art will know, snapshots are facilitated by so-called Copy-On-Write (COW) technology, explained more fully below. In addition, a snapshot does not actually make a copy of the data. Rather, as noted above, pointers (i.e., entries in exception tables) are used in conjunction with copies of blocks that are modified, in order to keep a record of the state of the data at the time of the snapshot. Each exception table entry is essentially a pointer with at least the block or chunk number in origin block storage resource that has been overwritten, and an address for the area of the COW that contains the origin data prior to being overwritten. There could also be additional information in an exception table entry, such as, for example, a timestamp of the creation of the entry. In this way, data can be frozen for various uses without actually affecting the data and without, for example, making an actual copy and sending a large amount of data, saving time and bandwidth. Exception tables actually exist both in memory for consulting, and as part of a COW for persistency, so that a table could be restored after a restart.

For purposes of snapshots, COW occurs when a write operation for a block is directed towards the origin resource that has one or more snapshots. In the present example, a single COW per volume is assumed, which is shared by snapshots of the same volume. However, it will be understood that a separate COW could be created for each snapshot, rather than using different areas of the same COW. If the block has not been written since the last snapshot, then before the write operation occurs, the content of the block is read and written out to a specially allocated storage area called “COW device.” Simultaneously, a corresponding exception table entry is created. Then the origin resource block is written with a new data. Subsequently, if the origin resource is read, then it would return the data from the block that was just written out; if the snapshot is read, then the exception table is consulted first, and since there is an entry for this block, the content is returned from the COW device. Note that an exception table is created for each snapshot.

Similarly, the effects over time of a read-write snapshot will now be described with reference to FIG. 2. Depicted in FIG. 2 is a block storage resource 200 at time T0. Assume that block storage resource 200 is part of an otherwise conventional computing network (e.g., LAN or WAN) in which iSCSI is used as a data transport protocol. The storage resource comprises four data storage blocks, 202, 204, 206 and 208. Assume that a request for a read-write snapshot of the four blocks has been made and the snapshot created and exported as an iSCSI target in the same manner as any iSCSI target. At time T1, a request to modify the contents of block 202 in the snapshot is received. In order to preserve the actual data for non-snapshot use, a copy of the contents of block 202 is placed in a spare block 210 of the storage device. Pointers are thereafter used to point to the data at block 210 as if it were at block 202. At time T2, the contents of block 202 are modified in accordance with the request, shown by reference 202.

As one skilled in the art will know, in the case of a read-write snapshot, the first modification (write) request follows the COW process describe above with respect to a read-only snapshot. However, upon a second modification request, the first modified block(s) is written out to a so-called writable copy-on-write (WCOW) storage resource that exists one per read-write snapshot. The operation is similar to COW; there is an exception table that is consulted when the requestor accesses the snapshot. If the snapshot is read-write and the block has been written out to it, it will subsequently be read from the COW and not from the block storage resource. If the block(s) has not been written out, the behavior follows that of a read-only snapshot.

The above-described computing environment and/or computing units are only offered as examples. The present invention can be incorporated and used with many types of computing units, computers, processors, nodes, systems, work stations and/or environments without departing from the spirit of the present invention. Other types of computing environments can benefit from the present invention and, thus, are considered a part of the present invention.

The present invention can include at least one program storage device readable by a machine, tangibly embodying at least one program of instructions executable by the machine to perform the capabilities of the present invention. The program storage device can be provided separately, or as a part of a computing unit.

The figures depicted herein are just exemplary. There may be many variations to these diagrams or the steps (or operations) described herein without departing from the spirit of the invention. For instance, the steps may be performed in a differing order, or steps may be added, deleted or modified. All of these variations are considered a part of the invention.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A method of providing a snapshot of data on a network, the method comprising:
taking a snapshot of a block storage resource on the network; and
exporting the snapshot over the network as an iSCSI target.

2. The method of claim 1, wherein the taking and the exporting are performed by a controller for the block storage resource.

3. The method of claim 1, wherein the snapshot comprises a read-only snapshot.

4. The method of claim 1, wherein the snapshot comprises a read-write snapshot.

5. A system for providing a snapshot of data on a network, the system comprising:
a block storage resource coupled to a network;
means for taking a snapshot of the block storage resource; and
means for exporting the snapshot over the network as an iSCSI target.

6. The system of claim 5, wherein the means for taking and the means for exporting comprise a controller for the block storage resource.

7. The system of claim 5, wherein the snapshot comprises a read-only snapshot.

8. The system of claim 5, wherein the snapshot comprises a read-write snapshot.

9. At least one program storage device readable by a machine tangibly embodying at least one program of instructions executable by the machine to perform a method of providing a snapshot of data on a network, the method comprising:
taking a snapshot of a block storage resource on the network; and
exporting the snapshot over the network as an iSCSI target.

10. The at least one program storage device of claim 9, wherein the taking and the exporting are performed by a controller for the block storage resource.

11. The at least one program storage device of claim 9, wherein the snapshot comprises a read-only snapshot.

12. The at least one program storage device of claim 9, wherein the snapshot comprises a read-write snapshot.
